(19) United States
(12) Patent Application Publication
(10) Pub. No.: US 2024/0396896 A1
(43) Pub. Date: Nov. 28, 2024

(54) Systems and Methods for Individual Identification Through Heuristics or Machine Learning

(71) Applicant: ConsumerDirect, Inc., Irvine, CA (US)

(72) Inventors: David B. Coulter, Tustin, CA (US); Christopher Peery, Mission Viejo, CA (US)

(21) Appl. No.: 18/674,770

(22) Filed: May 24, 2024

Related U.S. Application Data
(60) Provisional application No. 63/468,773, filed on May 24, 2023.

(51) Int. Cl. H04L 9/40; G06F 9/451

(52) U.S. Cl. CPC H04L 63/102; G06F 9/451

(57) ABSTRACT

A computerized method is disclosed including performing an automated scanning, based on a user profile, of one or more webpages for one or more candidate accounts forming a set of candidate accounts, wherein the user profile includes identifying data provided by a particular individual to whom the user profile corresponds, and wherein the candidate account includes information having a level of similarity to the user profile, performing an automated analysis of each of the set of candidate accounts to determine a score indicative of a likelihood for each candidate account of the set of candidate accounts and generating a graphical user interface illustrating at least a subset of the set of candidate accounts, wherein the graphical user interface is configured to receive user feedback indicating that a first candidate account of the subset of the set of candidate accounts is to be deleted from storage.

### CROSS-REFERENCE TO RELATED APPLICATIONS

This application claims the benefit of priority to U.S. Provisional Application No. 63/468,773 filed May 24, 2023, the entire contents of which are incorporated by reference herein.

### FIELD

Embodiments of the disclosure relate to the field of online data privacy. More specifically, one embodiment of the disclosure relates to a system for identifying candidate accounts associated with various websites across that the internet that include identifying information of a particular user such as name, place of residence, date of birth, profession, etc., utilize machine learning techniques to determine a likelihood of each candidate account corresponding to a particular individual, and enabling the particular individual to provide actionable feedback on results of the analysis, which may result in automated removal of a candidate account from a datastore of a website.

### BACKGROUND

In the early days of the internet, data collection was relatively straightforward with websites primarily collecting basic information such as email addresses and names through online fillable-forms. During this time, the concept of data privacy was not a significant concern for most users or developers. However, with the rise of e-commerce and social media, data collection practices expanded dramatically with companies beginning to collect detailed personal information. The collected data was initially touted as being used to enhance user experience, provide targeted advertisements, and improve services. During this time, the concept of internet cookies was developed, which was followed closely by the development tracking technologies enabling companies to follow user behavior across websites.

As the collection of detailed personal data became ubiquitous with surfing the internet, companies storing the detailed personal information began experiencing data breaches, which involved undesired or unexpected access of the stored personal information. Data breaches typically occur with malicious intent at the hands of cyberhackers or other threat actors. It was at this time that significant attention to the vulnerabilities in data security and privacy practices was made public through high-profile cases, such as data breaches occurring at Target Corporation in 2013 and Equifax, Inc., in 2017, and the Facebook-Cambridge Analytica scandal of 2018. These incidents exposed millions of users' personal information and highlighted the risks associated with inadequate data protection.

In response to growing public concern for data security, the General Data Protection Regulation (GDPR) was enacted in Europe in 2018 and numerous federal and state regulations were enacted in the United States including the California Consumer Privacy Act (CCPA) in 2020. These regulations set requirements for data protection, user consent, and data breach notifications and apply to many (if not all) companies processing personal data of residents of a particular location (e.g., Europe Union (EU), United States, California, etc.) regardless of the company's location.

In some regulations, such as the CCPA, individuals were granted rights concerning their personal data, such as the right to know what data is collected, the right to delete personal data, and the right to opt-out of the sale of personal data. In view of these regulations, a particular individual may request removal of their information from the records (data store) of a business. However, upon receipt of such a request, the receiving business often cannot positively identify which data belong to the particular, requesting individual. For example, numerous user accounts may exist in the records of the business that are linked to individuals that have the same name as the particular, requesting individual but not each of the accounts, if any, may actually correspond (belong) to the particular, requesting individual.

Thus, a business in such an instance encounters a problem in that data privacy laws and regulations require removal of the particular individual's data upon receipt of a removal request but the business is unclear how exactly to comply as the business is unable to positively identify the data corresponding to the particular, requesting individual thereby ensuring removal (deletion) of the correct data, and only the data belonging to the particular, requesting individual.

In some cases, businesses seeking to comply with data privacy laws and regulations will remove all data associated with any account linked to the same name as the particular, requesting individual. As a result, the business often removes far more data than is required per the request and removes data that the particular, requesting individual has no right or authority over. What is needed therefore is a system to positively identify accounts that belong to a particular individual to enable accurate removal of only accounts corresponding to the particular individual.

### BRIEF DESCRIPTION OF THE DRAWINGS

Illustrative examples are described in detail below with reference to the following figures:

FIG. 1 illustrates a networked environment in which an account identification system interfaces between webpages via the internet and an endpoint device to provide account identification data according to some embodiments;

FIG. 2 provides a flowchart illustrating operations of a process for identifying and analyzing candidate accounts for correspondence to a particular user, and presenting the results of the analysis in a graphical user interface configured to receive actionable user input in response thereto according to some embodiments;

FIG. 3 provides a flowchart illustrating operations of a process for automatically identifying candidate accounts on webpages accessible via the internet for correspondence to a particular user according to some embodiments;

FIG. 4 illustrates a process of identifying candidate accounts corresponding to a particular user and generating feature embeddings for use in analyses thereof according to some embodiments;

FIG. 5 illustrates a process of analyzing the feature embeddings of FIG. 4 with one or more machine learning models resulting in a prediction of the likelihood each candidate account corresponds to a particular user according to some embodiments;

FIG. 6 illustrates a process of providing a particular user results of analyses of candidate accounts, receiving actionable user feedback, and automating an action over the internet in response thereto according to some embodiments; and

FIG. 7 illustrates a logic diagram illustrating logic components of a account identification system according to an implementation of the disclosure.

### DETAILED DESCRIPTION

### Terminology

In the following description, certain terminology is used to describe various features of the invention. For example, each of the terms “logic,” “engine,” and “component” may be representative of hardware, firmware or software that is configured to perform one or more functions. As hardware, the term logic (or component) may include circuitry having data processing and/or storage functionality. Examples of such circuitry may include, but are not limited or restricted to a hardware processor (e.g., microprocessor, one or more processor cores, a digital signal processor, a programmable gate array, a microcontroller, an application specific integrated circuit “ASIC”, etc.), a semiconductor memory, or combinatorial elements.

Additionally, or in the alternative, the logic (or component) may include software such as one or more processes, one or more instances, Application Programming Interface(s) (API), subroutine(s), function(s), applet(s), servlet(s), routine(s), source code, object code, shared library/dynamic link library (dll), or even one or more instructions. This software may be stored in any type of a suitable non-transitory storage medium, or transitory storage medium (e.g., electrical, optical, acoustical or other form of propagated signals such as carrier waves, infrared signals, or digital signals). Examples of a non-transitory storage medium may include, but are not limited or restricted to a programmable circuit; non-persistent storage such as volatile memory (e.g., any type of random access memory “RAM”); or persistent storage such as non-volatile memory (e.g., read-only memory “ROM”, power-backed RAM, flash memory, phase-change memory, etc.), a solid-state drive, hard disk drive, an optical disc drive, or a portable memory device. As firmware, the logic (or component) may be stored in persistent storage.

Herein, a “communication” generally refers to related data that is received, transmitted, or exchanged within a communication session. The data may include a plurality of packets, where a “packet” broadly refers to a series of bits or bytes having a prescribed format. Alternatively, the data may include a collection of data that may take the form of an individual or a number of packets carrying related payloads, e.g., a single webpage received over a network.

The term “computerized” generally represents that any corresponding operations are conducted by hardware in combination with software and/or firmware.

The term “object” generally relates to content (or a reference to access such content) having a logical structure or organization that enables it to be classified for purposes of analysis as a cyberthreat such as malware or phishing. The content may include an executable (e.g., an application, program, code segment, a script, dynamic link library “dll” or any file in a format that can be directly executed by a computer such as a file having an extension of “.exe”, “.vbs”, “.js”, etc.), a non-executable (e.g., a storage file; any document such as a Portable Document Format “PDF” document; a word processing document such as WORD® document; an electronic mail “email” message, web page, etc.), or simply a collection of related data. Additionally, the term object may refer to an instance of an executable that is executing (“a process”). In one embodiment, an object may be an image data such as one or more images and/or videos. In another embodiment, an object may be a set of instructions that are executable by one or more processors. The object may be retrieved from information in transit (e.g., one or more packets, one or more flows each being a plurality of related packets, etc.) or information at rest (e.g., data bytes from a storage medium).

Examples of objects may include one or more flows or a self-contained element within a flow itself. A “flow” generally refers to related packets that are received, transmitted, or exchanged within a communication session. For convenience, a packet is broadly referred to as a series of bits or bytes having a prescribed format, which may, according to one embodiment, include packets, frames, or cells. Further, an “object” may also refer to individual or a number of packets carrying related payloads, e.g., a single webpage received over a network. Moreover, an object may be a file retrieved from a storage location over an interconnect. As a self-contained element, the object may be an executable (e.g., an application, program, segment of code, dynamically link library “DLL”, etc.) or a non-executable. Examples of non-executables may include a document (e.g., a Portable Document Format “PDF” document, MICROSOFT® OFFICE® document, MICROSOFT® EXCEL® spreadsheet, etc.), an electronic mail (email), downloaded web page, or the like.

The term “network device” may be construed as any electronic computing system with the capability of processing data and connecting to a network. Such a network may be a public network such as the Internet or a private network such as a wireless data telecommunication network, wide area network, a type of local area network (LAN), or a combination of networks. Examples of a network device may include, but are not limited or restricted to, an endpoint (e.g., a laptop, a mobile phone, a tablet, a computer, etc.), a standalone appliance, a server, a router or other intermediary communication device, a firewall, etc.

The term “rules” refers to logic used in executing certain operations, wherein execution may vary (or not occur) based on a rule. Each rule is capable of being represented as a logical expression for example, such as an “if this, then that” statement, where “this” represents a condition, and “that” represents the conclusion. The conclusion is applied when the condition is met by analysis of parameters (predetermined or dynamically obtained). The term “implicated rules,” as used herein, are the one or more specific rules applied in reaching a verdict, reflecting predetermined or dynamically obtained parameters and the conclusions drawn from them based on the logical expressions.

According to one embodiment of the disclosure, rules may also provide configuration information containing parameter values such as, for example, threshold values used in detection (e.g., specifying a time a player has a ball, a velocity of a pass or shot, a number of goals, etc.). Rules may be stored in a rules store (e.g., a repository) in persistent memory of a network device and are typically updated frequently (periodically or aperiodically).

Finally, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure is to be considered as an example of the principles of the invention and not intended to limit the invention to the specific embodiments shown and described.

In some embodiments of the disclosure, a computerized method is disclosed that comprises operations of performing an automated scanning, based on a user profile, of one or more webpages for one or more candidate accounts forming a set of candidate accounts, wherein the user profile includes identifying data provided by a particular individual to whom the user profile corresponds, and wherein the candidate account includes information having a level of similarity to the user profile, performing an automated analysis of each of the set of candidate accounts to determine a score indicative of a likelihood for each candidate account of the set of candidate accounts, and generating a graphical user interface illustrating at least a subset of the set of candidate accounts, wherein the graphical user interface is configured to receive user feedback indicating that a first candidate account of the subset of the set of candidate accounts is to be deleted from storage.

The computerized method may also include generating removal instructions based on the user feedback, and automatically transmitting the removal instructions to a webpage to which the first candidate account corresponds or to an email of a business entity storing the first candidate account. In some embodiments, automatically transmitting the removal instructions to the webpage to which the first candidate account corresponds includes automatically populating fields within a form or web portal provided by the webpage. In some examples, the automated scanning is performed by one or more programming scripts configured, upon execution by one or more processors, to access the one or more webpages and attempt to access user accounts or user data stored or accessible by the one or more webpages based on a predetermined structure of the one or more webpages.

In some instances, the automated analysis of each of the set of candidate accounts includes processing each of the set of candidate accounts and the user profile with a trained machine learning model to determine a similarity score for each of the set of candidate accounts relative to the user profile. In some embodiments, the computerized method includes performing a feature embedding process on each of the set of candidate accounts and the user profile, wherein resultant feature embeddings are provided to the trained machine learning model as input. In some instances, the automated analysis of each of the set of candidate accounts includes generating a feature embedding for each of the set of candidate accounts and the user profile, and determining a similarity between (i) the feature embedding for each of the set of candidate accounts, and (ii) the feature embedding of the user profile. The computerized method may be performed by logic that is stored on a non-transitory, computer-readable medium and configured to be executed by one or more processors.

As touched on above, internet data privacy refers to the protection of personal information and data transmitted or stored online. Data privacy further encompasses the control individuals have over the collection, use, and sharing of their personal data when using the internet. With the increasing reliance on digital platforms, data privacy has become a significant concern due to the potential misuse, unauthorized access, and exploitation of personal information.

Several key aspects contribute to internet data privacy including data storage security, data usage and sharing, user content, anonymization and encryption, legal regulatory frameworks, and user awareness. Data Collection may refer to websites, online services, and applications such as those processing on an endpoint device (e.g., mobile phone) collecting user data such as names, email addresses, internet browsing habits/history, location information, and more. For instance, data may be collected through cookies, tracking pixels, registration forms, and other means. Referring to data storage and security, once collected, user data may be stored in databases, cloud servers, or other systems. Protecting this data from unauthorized access, hacking attempts, or breaches is crucial to maintaining privacy.

Referring to data usage and sharing, companies may use collected data for various purposes, such as improving their services, personalizing user experiences, or targeted advertising. Data may also be shared with third parties, such as advertisers or business partners. Transparency regarding data usage and sharing is essential to safeguard privacy. Privacy regulations and policies often require explicit user consent for data collection and processing. Users should be informed about the types of data being collected, how it will be used, and with whom it may be shared. They should have the right to opt in or out of data collection and to withdraw consent at any time. To protect privacy, data can be anonymized or aggregated to remove personally identifiable information. Encryption techniques can also be employed to secure data during transmission or storage, making it unreadable to unauthorized individuals.

Referring to legal and regulatory frameworks, governments and regulatory bodies establish laws and regulations to protect data privacy. Examples include the European Union's General Data Protection Regulation (GDPR) and the California Consumer Privacy Act (CCPA), which outline obligations for organizations handling personal data. With respect to user awareness and control, internet users play a vital role in protecting their own data privacy. Being informed about privacy policies, understanding the implications of sharing personal information, and utilizing privacy settings and tools provided by platforms are essential practices.

Data privacy concerns arise due to the potential risks associated with misuse or unauthorized access to personal information. These risks include identity theft, fraud, unwanted surveillance, data breaches, discrimination, and loss of control over personal data. To mitigate these risks and ensure data privacy, individuals and organizations can adopt measures such as using secure passwords, employing encryption, regularly updating software, being cautious of phishing attempts, and staying informed about privacy practices and regulations. Additionally, advocating for stronger privacy laws and supporting technologies that prioritize user privacy can contribute to a safer and more privacy-conscious internet environment.

In some jurisdictions, companies are required to delete personal data (e.g., personal account information) it has stored upon request (where the data deleted may depend on the request and the nature of the data being requested for deletion). For example, the European Union's GDPR grants individuals the right to request the deletion of their personal data under certain circumstances, such as when the data is no longer necessary for the purposes for which it was collected or when the individual withdraws their consent. In such cases, organizations are generally required to delete the data, unless there are other legal grounds for keeping it.

Similarly, the California Consumer Privacy Act (CCPA) gives California residents the right to request the deletion of their personal information from businesses subject to the law. The CCPA grants consumers greater control over their personal data and requires businesses to be transparent about their data collection and usage practices.

Key points regarding data removal under the CCPA include: the right to deletion, exceptions to the right to delete, verification process, notice of deletion rights, service provider obligations, and record-keeping exemptions. Consumers in California have the right to request the deletion of their personal information held by businesses. Upon receiving a verified request, businesses are generally obligated to delete the requested information. However, there are some exceptions to the deletion requirement. Businesses may not have to comply with deletion requests in certain situations, such as when the data is necessary for completing a transaction, detecting security incidents, exercising free speech rights, or complying with legal obligations. Businesses are required to establish processes for verifying consumer requests to prevent unauthorized access to or deletion of personal information.

Businesses subject to the CCPA must inform consumers about their right to request the deletion of their personal information. This notice should be provided in a readily understandable format, such as a privacy policy, and should include information on how to submit deletion requests. If a business receives a deletion request from a consumer, it must also direct any service providers to delete the consumer's personal information unless the service provider needs the information for performing services on behalf of the business. The CCPA allows businesses to maintain records of deletion requests and the basis for their decision not to comply if necessary for certain purposes, such as protecting against fraudulent or illegal activities. Overall, the CCPA aims to give consumers more control over their personal information and the ability to request its deletion from businesses subject to the law.

As should be understood from the above, companies/websites, often referred to as “data brokers” or “business entities” store vast numbers of user accounts, each of which include various data points of (personal) information that is linked to the account holder. A particular individual may hold one or more accounts with one or more data brokers. Further, business entities may trade data between each other, e.g., for other accounts and/or monetary amounts. Thus, a particular individual's data can be spread over a vast decentralized network, with no way of knowing which business entities hold the particular individual's data, and what the business entities are doing with the data.

### Account Identification System

As a brief summary, one embodiment disclosed herein includes a computerized method involving operations of receiving information of a particular individual and initiating a scan of websites and website databases for personal accounts potentially belonging to the particular individual (referred to herein as “candidate accounts”), where the scan may be performed by automated programs or scripts, which are often referred to as “internet bots” or “bots.” Additionally, the computerized method includes an automated analysis of the candidate accounts identified by the bots through heuristics, one or more rule sets, and/or machine learning techniques to determine the likelihood that each candidate account actually belongs to the particular individual. Further, the computerized method may include generation of a graphical user interface (GUI) that is configured to display a listing of the candidates accounts that satisfy a likelihood comparison (e.g., satisfy a threshold comparison) and the company/website storing the data.

The GUI may be configured to receive user input (user feedback) that may: verify the account does in fact correspond (belong) to the particular individual (“positive identification”), pertain to a removal request of an account, pertain to an allowance of continued storage of the personal account by a business entity, and/or indicate that the candidate account does not belong to the particular individual (“negative identification”).

Discussed below are embodiments of the computerized method, a system for performing operations of the computerized method, and logic stored on non-transitory, computer-readable medium that, when executed by one or more processors, causes performance of operations of the computerized method. In one embodiment, a particular individual (e.g., John Smith) registers or “signs up” with an account identification system or otherwise provides personal information to the account identification system. The data provided by the particular individual may include initial personally identifiable information (PII), which may include name, date of birth (DOB), social security number (SSN), mailing address, residency information, etc. The account identification system may create a user profile for the particular individual.

In some embodiments, the account identification system may augment the user profile with additional information from one or more databases such as proprietary, confidential databases and/or third party databases (e.g., credit report bureau databases). The augmented information may include personal, financial, or credit data such as credit scores from one or more of the major credit reporting bureaus (Experian PLC, TransUnion Holding Company, Inc., or Equifax, Inc.), medical information, bio-markers, facial recognition data, genetic profiles, etc.

Additionally, the account identification system automatically searches or scans websites (e.g., a collection of related webpages) and associated databases for information having common features with the user profile of the particular individual such as name, city of residence, date of birth, etc. In some examples, one or more bots may scan websites and associated databases for accounts that include one or more of the features present within the user account of the particular individual. In some embodiments, an online account having a threshold number of features in common with features of the user profile results in the online account being identified as a “candidate account.” In other embodiments, the features may be weighted such that an online account that includes one or more features having a combined weight above a threshold is identified as a candidate account.

In some embodiments, the websites searched or scanned include business entities such as “1800USSearch.com,” “411.com,” “ACCU.com,” “addresses.com,” etc. In some instances, the creation of a user profile by the account identification system may initiate or trigger one or more internet bots to automatically search or scan websites for such information described above. In some embodiments, one or more bots may be deployed for each website, where a bot may be a computer program or script that is executable by a processor and is configured to parse website code and/or interact with website code in an automated manner based on a predetermined template generated for a particular website. Thus, such a template may indicate search boxes on the website and/or navigation instructions for the website, that in combination with the user profile of the account identification system, enables the bots to search/parse a website for any stored information of the particular individual that was discovered by the bots (“discovered data”).

Based on the identified candidate accounts and in view of the user profile of the particular individual, the account identification system may generate a list of candidate accounts stored by business entities (e.g., held by data brokers) that may belong to the particular individual. In some embodiments, the list may be ranked in order of likelihood (probability or score) based on the application of one or more rule sets, heuristics, and/or machine learning techniques. In some instances, analyses may be performed on each candidate account identified by the internet bots resulting in a score indicative of a likelihood that each candidate account corresponds to the particular individual and those candidate accounts having a score that meets or exceeds a threshold are provided to the particular individual via a graphical user interface and those that fail to meet the threshold may be dismissed (e.g., not presented to the particular individual).

As one example, a predictive machine learning (ML) model may be trained on predetermined training data of paired candidate accounts and user profiles. For instance, curated data may be provided to train a predictive ML model, where the curated data is manually paired accounts and profiles and/or historical data of accounts and profiles confirmed by real users (and/or vice versa negative confirmations indicating an account does not pair with a profile). The ML model may be retrained using additional input from users as such input is received over time (e.g., positive/negative identification from users is used as input to retrain the ML model, where in some embodiments, positive/negative identification from users is provided a higher weighting than manually curated pairings, and/or more recent positive/negative identification from users are afforded a higher weighting than older positive/negative identification from users). Examples of possible predictive ML m that may be utilized to train a predictive ML model include, but are not limited or restricted to, linear regression, logistic regression, linear discriminant analysis, classification and regression trees, naive bayes, K-nearest neighbors (KNN), learning vector quantization (LVQ), support vector machines (SVM), and/or random forest.

In other embodiments, the account identification system may perform a comparison between the content within fields of the user profile to content within fields of each candidate account, where examples of fields may include name (e.g., to match spelling, comparing “John” to “Jon”), residency information (e.g., city, state), DOB, occupation, social security number (SSN), number of bank accounts, names of bank accounts, etc. The comparison of a candidate account and the user profile may result in a numerical value (score) of the account. Fields may be weighted such that matching of a first field may provide a greater increase to the score than matching of a second field.

The score or percentage of each candidate account after analysis by the account identification system may then be compared to a threshold, where based on the threshold comparison, the candidate account may be included in the list of accounts provided to the user for user confirmation. For instance, when the score or percentage meets or exceeds the threshold, the candidate account presented to the particular individual.

As mentioned above, the list of candidate accounts may be presented to the user for confirmation or verification via a graphical user interface (GUI). The GUI may be a display screen of a mobile application (“app” or “mobile app”) configured for display/rendering on a mobile phone, tablet, laptop computer, etc. In other embodiments, the GUI may be a display screen configured to be rendered or displayed via a web browser application (e.g., GOOGLE® CHROME®, SAFARI®, etc.). In either case, the account identification system may require some login information/credentials from the particular individual, e.g., username/password, biometric data (e.g., facial recognition, fingerprint scan), etc. As discussed herein, the account identification system may receive user feedback for one or more candidate accounts including positive or negative identification, or a request for the deletion (removal) of the data associated with a candidate account (or deletion of the candidate account in its entirety). The account identification may then cause deletion or removal of the data and/or candidate account, e.g., through transmission of specific and particular instructions to the business entity storing the candidate account. In some examples, the specific and particular instructions take the form of a request for removal that adheres to the guidelines and regulations discussed above.

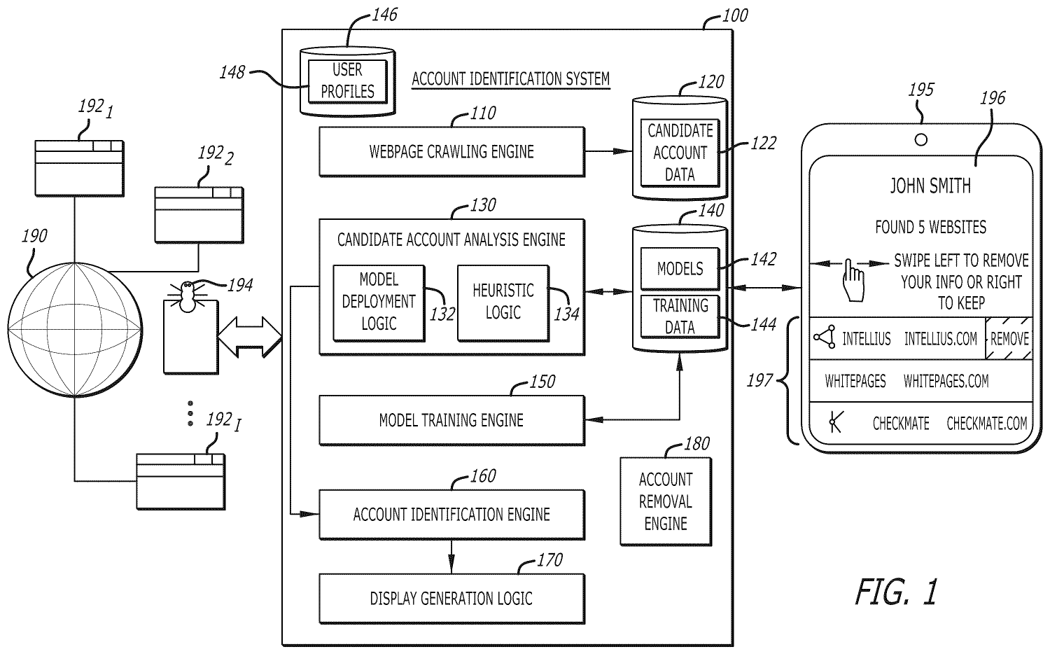

Referring now to FIG. 1, a networked environment in which an account identification system interfaces between webpages via the internet and an endpoint device to provide account identification data is shown according to some embodiments. The networked environment of FIG. 1 illustrates components that may be communicatively coupled via one or more networks, such as the internet 190. The components included in the networked environment of FIG. 1 include an account identification system 100, a set of websites or webpages 192₁-192ᵢ (where i>1) (collectively or individually, “webpages 192”), one or more internet bots 194, and an endpoint device 195 that may be operable by a particular individual (e.g., “John Smith”).

In particular, the account identification system 100 may be comprised of a plurality of logic modules such as a webpage crawling engine 110, a candidate account analysis engine 130, a model training engine 150, an account identification engine 160, a display generation logic 170, and an account removal engine 180. The candidate account analysis engine 130 is shown to include sub-logic modules such as a model deployment logic 132 and a heuristic engine 134. Further, the account identification system 100 may further comprised a first database 120 configured to store candidate account data 122 (e.g., the identified candidate accounts), a second database 140 configured to store one or more trained ML models 142 and training 142, and a third database 146 configured to store user profiles 148.

As discussed above, the account identification system 100 may perform an automated process that is discussed in more detail below. As a high-level summary, and assuming data and information corresponding to a particular has been received and a user profile generated, the automated process may include the webpage crawling engine 110 deploying one or more internet bots 194 to scan one or more webpages 192 via the internet 190. In some embodiments, a predetermined list of webpages 192 is maintained such that an internet bot 194 is developed to scan a particular webpage 192, e.g., the webpage 192₁. As discussed above, an internet bot 194 identifies an online account as a candidate based on features of the online account in view of the user profile. Online accounts identified as candidate accounts may be stored in the database 120 as candidate account data 122.

In determining candidate accounts to display to the particular individual that form the candidate account listing 197, the candidate account analysis engine 130 may perform one or more automated analyses on the candidate accounts to generate a score indicative of the likelihood that a particular candidate account corresponds (belongs) to the particular individual. As one example, the model deployment logic 132 may access a model 142 and provide the model 142 with the candidate accounts and the user profile 148 of the particular individual as input, which processes the input resulting in a likelihood score of each candidate account. Additional detail pertaining to the machine learning analysis is provided below. In other embodiments, a heuristic engine 134 may be deployed that applies heuristics or rule sets to each candidate account in view of the user profile 148 as discussed above.

The likelihood scores of each of the candidate accounts generated by the candidate account analysis engine 130 may be obtained by the account identification engine 160, which may be configured to apply one or more thresholds to the likelihood scores. The account identification engine 160 may indicate a candidate account for inclusion on the candidate account listing 197 when the likelihood score of the candidate account satisfies a threshold comparison and may dismiss, disregard, or otherwise mark a candidate for exclusion on the candidate account listing 197 when the likelihood score of the candidate account fails to satisfy a threshold comparison. In some embodiments, a plurality of thresholds may be applied where a first, highest threshold may correspond to the greatest likelihood that a candidate account corresponds to the particular user (e.g., a score corresponding to at least 0.75) and a second, lower threshold may correspond to a lesser likelihood that a candidate account corresponds to the particular user (e.g., 0.50≤score<0.75). In such instances, the candidate account listing 197 may indicate the tier in which a particular candidate account falls into. Further, in some embodiments, the GUI may be configured to specifically request that the particular individual provide user input corresponding to a positive/negative identification of each candidate account falling into the lower tier (e.g., 0.50≤score<0.75).

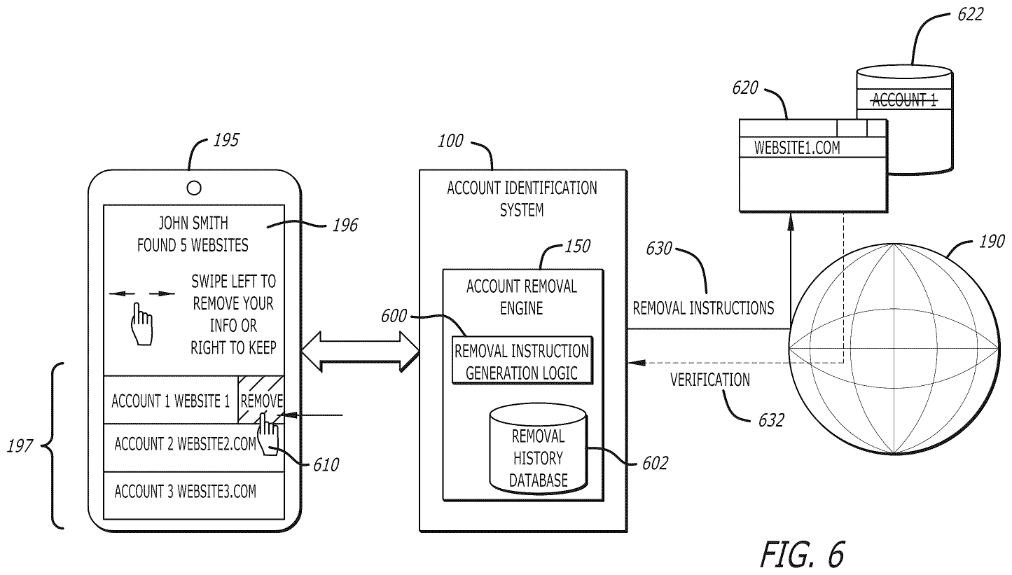

FIG. 1 illustrates one example of the GUI described above presented to a user (particular individual) configured to receive user input pertaining to positive/negative identification of a candidate account and/or instructions to have a candidate account or data therein removed. The GUI includes a main display 196 that may provide a total number of candidates accounts that were identified by the internet bots and satisfied a threshold comparison following performance of a scoring analysis (e.g., “Found 5 websites . . . ”). The GUI may also include a listing of such candidate accounts 197. Additionally, discussion pertaining to the GUI and user feedback received by the account identification system therefrom is provided along with the description of FIG. 6.

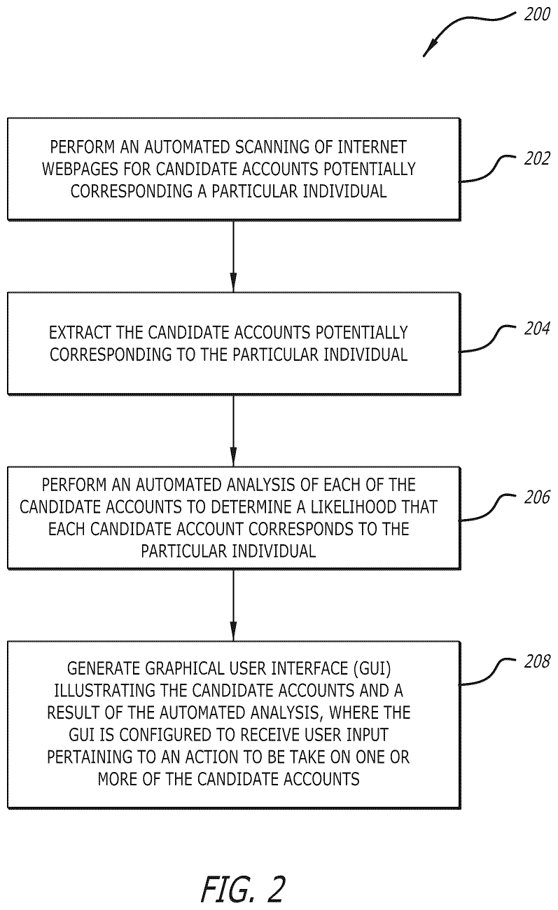

Referring to FIG. 2, a flowchart illustrating operations of a process for identifying and analyzing candidate accounts for correspondence to a particular user and presenting the results of the analysis in a graphical user interface configured to receive actionable user input in response thereto is shown according to some embodiments. Each block illustrated in FIG. 2 represents an operation in the process 200 performed by, for example, the account identification system 100 for FIG. 1. It should be understood that not every operation illustrated in FIG. 2 is required. In fact, certain operations may be optional to complete aspects of the process 200. Prior to the initiation of the process 200, it may be assumed that a particular individual has provided the account identification system 100 with personal information such that a user profile for the particular individual has been generated.

The process 200 begins with performance of an automated scanning of internet webpages for candidate accounts potentially corresponding to the particular individual, e.g., in view of the content of the user profile (block 202). For each candidate identified during the automated scanning, the candidate account or a copy of the contents thereof along with any metadata (“candidate account data”) is extracted from the webpage or associated datastore (block 204). As shown in FIG. 1, the extracted candidate account data may be stored in a database associated with the account identification system 100.

The account identification system 100 may then perform an automated analysis of each of the candidate accounts to determine a likelihood that each candidate account corresponds to the particular individual (block 206). The automated analysis may include processing by a trained machine learning model, application of heuristics, and/or application of one or more rule sets as discussed in detail herein. The likelihood of a candidate account may refer to a score generated by the account identification system 100 such as a score generated by a machine learning model indicating the likelihood that a particular candidate account corresponds to the user profile.

Following the determination of the likelihood of each candidate account, one or more of the candidate accounts may be displayed to the particular individual via a graphical user interface (GUI) rendered on an endpoint device of the particular individual (block 208). In some embodiments, the GUI may be configured to receive user input pertaining to an action to be taken on one or more of the candidate accounts, such as cause deletion of the candidate account or data therein.

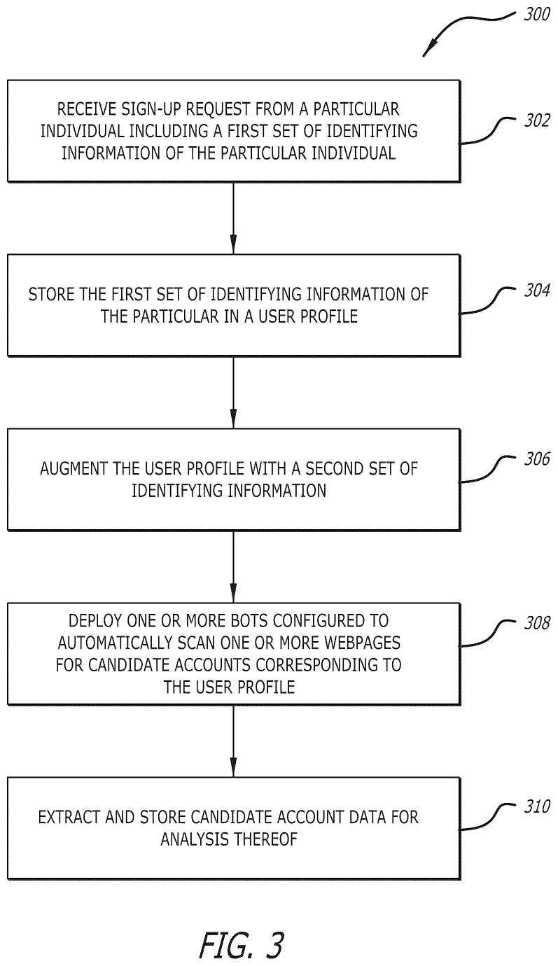

Referring now to FIG. 3, a flowchart illustrating operations of a process for automatically identifying candidate accounts on webpages accessible via the internet for correspondence to a particular user is shown according to some embodiments. Each block illustrated in FIG. 3 represents an operation in the process 300 performed by, for example, the account identification system 100 for FIG. 1. It should be understood that not every operation illustrated in FIG. 3 is required. In fact, certain operations may be optional to complete aspects of the process 300. The process 300 begins with receipt of a sign-up or registration request from a particular individual that includes a first set of identifying information from the particular individual (block 302). Examples of identifying information included in the first set of identifying information may include initial personally identifiable information (PII) such as full legal name, date of birth (DOB), social security number (SSN), mailing address, residency information, etc.

The first set of identifying information may then be stored in a user profile (block 304). Optionally, the account identification system 100 may augment the user profile with a second set of identifying information (block 306). Examples of identifying information included in the second set of identifying information may include personal, financial, or credit data such as credit scores from one or more of the major credit reporting bureaus (Experian PLC, TransUnion Holding Company, Inc., or Equifax, Inc.), medical information, bio-markers, facial recognition data, genetic profiles, etc. Augmentation may include querying the major credit reporting bureaus, health care providers for electronic medical records, etc., and storing the second set of identifying information in the user profile. In some instances, duplicative information in the second set of identifying information is dismissed. In instances in which a contradiction exists between content of the first and second sets of identifying information, the particular user may be prompted via a GUI to select the correct information (e.g., a full legal name may be clarified, a full residential address may be clarified, a bank account number may be corrected, etc.) For example, the two pieces of contractor information may be placed side-by-side with a request to provide user input selecting the correct version.

Upon generation of the user profile, one or more internet bots may be deployed to automatically scan one or more webpages for candidate accounts likely to correspond to the user profile (block 308). As discussed above, an internet bot may be configured to scan a particular webpage or website based on predetermined knowledge of the webpage or website structure, and may optionally be configured to provide user profile data to execute forms on the webpage or website in order access user data or online accounts stored by the webpage or website. The candidate accounts may be extracted and stored for future analysis by the account identification system 100 (block 310).

### Generation of Candidate Account Feature Embeddings

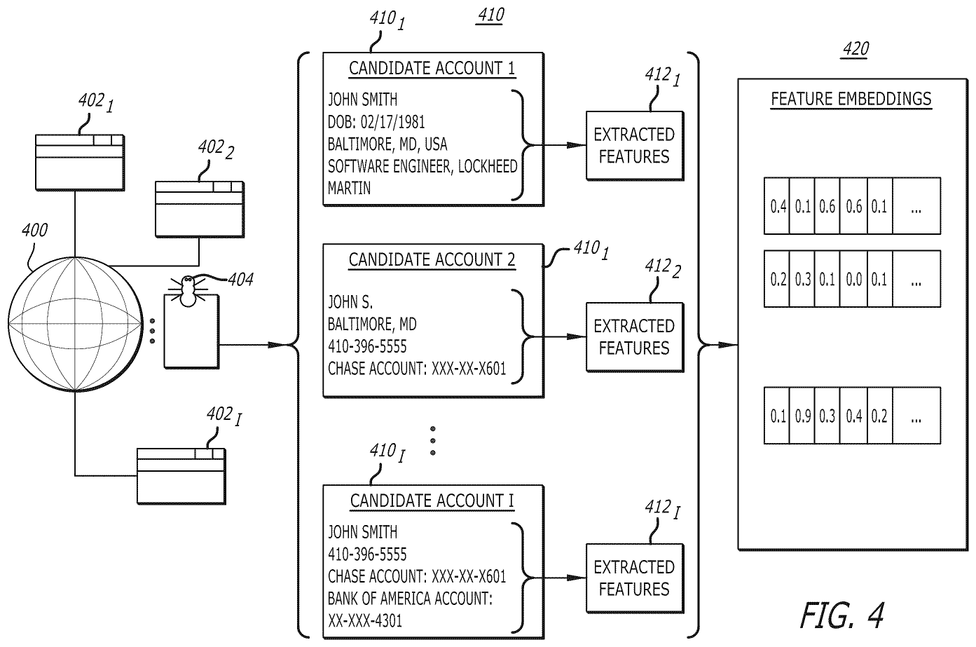

Referring now to FIG. 4, a process of identifying candidate accounts corresponding to a particular user and generating feature embeddings for use in analyses thereof is shown according to some embodiments. The illustration of FIG. 4 shows one or more internet bots 404 deployed to scan one or more webpages 402₁-402ᵢ (collectively or individually, “webpages 402”) via the internet 400. FIG. 4 further illustrates a set of candidate accounts 410 were identified by the internet bot 404 and are comprised of a candidate accounts 410₁-410ᵢ, with each candidate account comprising candidate account data such as name, date of birth, residence (e.g., city, state, country), profession, telephone number, bank account information, etc., where each may be referred to as a feature.

Following extraction of the candidate account data from the candidate accounts 410, the individual features of each candidate account 410₁-410ᵢ are extracted as extracted features 412₁-412ᵢ. A feature embedding process is performed by the account identification system 100 of FIG. 1, e.g., by the webpage crawling engine 110, resulting in feature embeddings 420, which may also be stored in the database 120 of FIG. 1.

The process of generating the feature embeddings 420 may include of transforming the extracted features 412₁-412ᵢ into numerical vectors configured to be provided as input a machine learning model for analysis. Specifically, most machine learning models require a numerical input and the feature embeddings 420 provide the necessary numerical representation of the extracted features 412₁-412ᵢ.

The process of generating the feature embeddings 420 may include pre-processing the text of the extracted features 412₁-412ᵢ, which may include tokenization of words comprising the extracted features 412₁-412ᵢ (e.g., [John; Smith], [Baltimore; MD; USA], etc.), converting all characters of the tokens to lower case, and eliminating punctuation. Any of various techniques may be utilized to convert the tokenized text into numerical vectors such as generating a sparse vector where each dimension corresponds to a unique word in the corpus (text of an extracted feature 412) (e.g., “Bag of Words (BoW)” technique). An alternative method is the Term Frequency-Inverse Document Frequency (TF-IDF), which involves weighing the frequency of the words by how important each is within the corpus, reducing the weight of common words across many documents. Other techniques includes Word2Vec (e.g., which uses a neural network and may be either continuous bag of words (CBOW) or skip-gram), Global Vectors for Word Representation (GloVe), or FastText. Yet other techniques include Embeddings from Language Models (ELMo), Bidirectional Encoder Representations from Transformers (BERT), or a pre-trained language model.

It should be understood that user profile embeddings may be generated from the data comprised the user profile in the same manner as discussed above. For example, the features of the user profile may be preprocessed as discussed above and converted into a numerical vector by any of the techniques referenced above.

### Machine Learning Analysis of Account Feature Embeddings

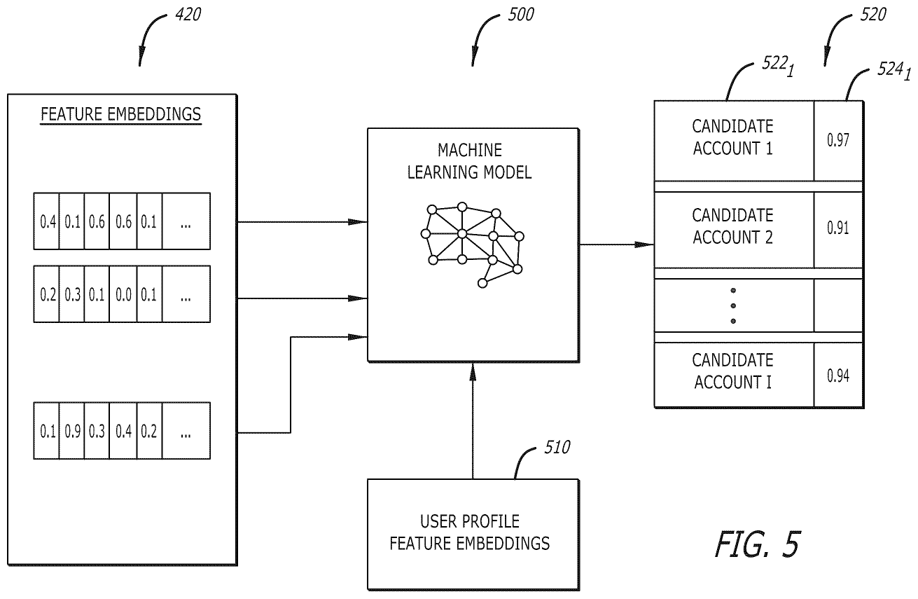

Referring to FIG. 5, a process of analyzing the feature embeddings of FIG. 4 with one or more machine learning models resulting in a prediction of the likelihood each candidate account corresponds to a particular user is shown according to some embodiments. The illustration of FIG. 5 shows the feature embeddings 420 of FIG. 4 and user profile feature embeddings 510 being provided to a machine learning model 500 as input. The machine learning 500 processes the input resulting in a scoring 520 comprised of a score for each candidate account indicative of the likelihood that a particular candidate account corresponds to user profile.

The machine learning model 500 may represent various machine learning models such as K-nearest neighbor (KNN), support vector machines (SVM), neural networks, autoencoders, metric learning models, t-distributed stochastic neighbor embedding (t-SNE), etc. For example, a KNN model may be configured to determine similarity between a feature embedding of a first candidate account and a feature embedding of the user profile based on distance metrics such as Euclidean or Manhattan distance.

While FIG. 5 illustrates the use of a machine learning model 500 to determine the scoring 520, the account identification engine 150 of the account identification 100 of FIG. 1 may utilize other methods for determining the similarity between a feature embedding of a first candidate account and a feature embedding of the user profile such as determining a cosine similarity, a Euclidean distance, a Manhattan distance, etc.

### Actionable User Feedback for Automated Removal of Candidate Account

Referring now to FIG. 6, a process of providing a particular user results of analyses of candidate accounts, receiving actionable user feedback, and automating an action over the internet in response thereto is shown according to some embodiments. FIG. 6 illustrates an example GUI (e.g., similar to that shown in FIG. 1) on an endpoint device 195 of the particular individual, e.g., “John Smith”. FIG. 6 illustrates that the GUI has received user input 610, as a “swipe left,” indicating that the account 1 of website1.com is to be removed (deleted).

The user input 610 is received by the account removal engine 150, which is shown in the embodiment of FIG. 6 to include a removal instruction generation logic 600 and a removal history database 602. The user input 610, candidate account listing 197, and other metadata associated with the user input 610 may stored in the removal history database 602 (e.g., date and timestamp, score generated by a machine learning model, version of the machine learning model, extracted features, feature embedding, etc.), which may enable review and auditing of the removal of the candidate account at a later date.

The removal instruction generation logic 600 may be configured to generate removal instructions 630 based at least on the user input 610 and candidate account selected for deletion. As one example, the removal instructions 630 may correspond to a particular request required by website1.com for notification of the removal instruction along with credentials or identifying information of the particular individual. For example, the removal instruction generation logic 600 may access the privacy policy of website1.com (e.g., in the same manner at the internet bot 194 of FIG. 1 accesses webpage data) and may (i) retrieve an email address listed in the privacy to which removal instructions are to be sent, automatically generate an email with templated instructions to remove the account pertaining to the name of the particular individual as obtained from the user profile along with the account identifying information such as a set of features included in the account, or (ii) automatically populate a form or web portal provided by the website1.com. In some examples, a verification of removal 632 may be obtained by the removal instruction generation logic 600 and stored in the removal history database 602. In examples in which an email is automatically generated and transmitted to the provided email address, a copy of the email may also be stored in the removal history database 602.

Referring to the GUI, in some examples, the GUI may display the list of candidate accounts 197 and information about each account to help the particular individual to determine if the account belongs to them, e.g., which data broker holds the account, and/or data points associated with the account, e.g., publicly available information. Additionally, the account identification system 100 may display challenge questions to a particular individual to determine if the particular individual is the account holder without disclosing someone else's private information to the particular individual. An example challenge question may ask the amount of a recurring payment to AT&T for a particular account, where the answer is known by the account identification system. The challenge questions are not illustrated but one example may include a pop-up that provides a question and a blank text box in which the particular individual using the endpoint device 195 is to provide an answer.

In some embodiments, the GUI is configured to receive specific user input indicating whether the account belongs to the particular individual. For example, the GUI may be configured to swipe left or right to indicate as such (e.g., swipe left refers to verify account belongs to the particular individual and delete account, swipe right refers to verify account belongs to the particular individual and allow the account to persist, hold/select of the listing refers to denying the account belongs to the particular user, etc.). It should be understood that alternative user input may refer to alternative options. Advantageously, this methodology provides a centralized list of accounts to the particular individual where the particular individual can process (verify/deny) the listing of accounts in a quick and easy way. Thus, a particular individual is not required to search websites and try to find accounts that may belong to him/her. Additionally, the particular individual is not required to complete additional steps to have the account deleted as such is automatically initiated by the account identification system.

In some embodiments, when the particular individual confirms that account is theirs (e.g., a “positively identified account”), the account identification system may also receive any of the following indications via the user input: remove the data; keep the data and do not share the data; keep the data and OK to share (e.g., may include a reimbursement option from the company/website storing/sharing the data such that the user is reimbursed a predetermined amount each time the data is shared). As a result, such actions keep the particular individual in control of their personal data and are easily and quickly able to decide which companies/websites may keep and/or share their data. Additional information may be found in U.S. Publication No. 2022/0309168, titled “System and Method for Protection of Personal Identifiable Information,” filed Mar. 25, 2022, the entire contents of which are incorporated by reference herein.

In some embodiments, when the particular individual confirms an account on the listing does not belong to him/her (e.g., a “negatively identified account”), the account identification system automatically removes the account from the accounting listing and may utilize the feedback to modify predefined rules, weightings, heuristics, etc., to determine which accounts are to be included in future accounting listings provided to the particular individual.

Thus, the account identification system is configured to avoid showing the same account twice on the listing of accounts, unless there is a significant change in information associated with the account, and/or change in the rules used to determine if account belongs to particular individual. In addition, the account identification system may include an auditing feature such that all user input along with the account to which the user input provides is logged or stored for a predetermined time period (e.g., 2 years, 3 years, etc.). As a result, a company, organization, government entity, etc., may request an audit of particular actions taken by a particular individual so that the account identification system may provide indicative proof that a particular individual took a particular action (e.g., delete, keep, share, etc.), where such is based on the fact he/she logged into the account identification system to view the GUI to provide input pertaining to an account.

### Logical Representation

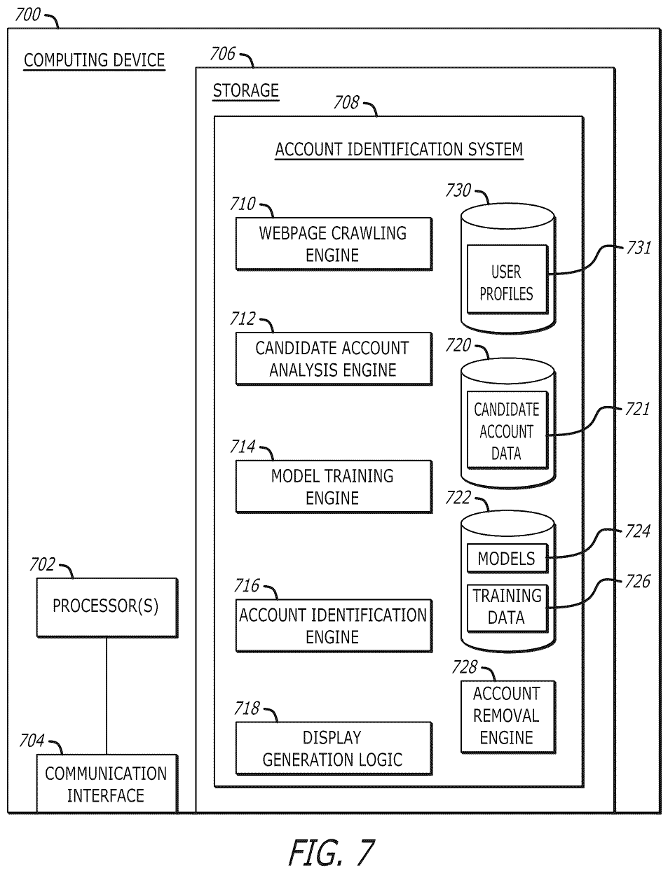

Referring now to FIG. 7, a logic diagram illustrating logic components of an account identification system is shown according to some embodiments. In the example shown in FIG. 7 a computing device 700 includes one or more processors 702 that is communicatively coupled to a communication interface 704 and storage 706, which may be non-transitory computer readable medium. The storage 706 may have stored thereon logic, e.g., in the form of computer-executable instructions, that, when executed by the processor 702, cause the processor 702 to perform the methods described herein.

As used herein, one implementation of a computing device may be a server device that has a memory for storing program code instructions and a hardware processor for executing the instructions. The server device can further include other physical components, such as a network interface or components for input and output. The storage 706 may include components that collectively may be referred to as an account identification system 708, which includes a webpage crawling engine 710, a candidate account analysis engine 712, a model training engine 714, an account identification engine 716, a display generation logic 718, and an account removal engine 728.

The model training engine may be configured to train a machine learning model which may include splitting the training data 726 into training and testing (or validation) sets and providing the training set to the model as input. The model processes the input by “learning” patterns through adjustment of model parameters in order to minimize a loss function. During training, the performance of the model is evaluated on the testing set. Additionally, hyperparameters may be tuned.

Additionally, the account identification system 708 may also include various data stores as needed to store data discussed above and, for example, may include specific data stores such as a data store 720 for storing candidate account data and a data store 722 for storing trained models 724 and training data 726. In some examples, the data storages may be stored elsewhere and be accessible to the account identification system 708. Examples of such storage include non-transitory computer-readable mediums, such as a magnetic or optical storage disk or a flash or solid-state memory, from which the program code can be loaded into the memory of the computing device 700 for execution. The term “non-transitory” refers to retention of the program code by the computer-readable medium while not under power, while volatile or “transitory” memory or media requires power in order to retain data.

Various examples and possible implementations have been described above, which recite certain features and/or functions. Although these examples and implementations have been described in language specific to structural features and/or functions, it is understood that the subject matter defined in the appended claims is not necessarily limited to the specific features or functions described above. Rather, the specific features and functions described above are disclosed as examples of implementing the claims, and other equivalent features and acts are intended to be within the scope of the claims. Further, any or all of the features and functions described above can be combined with each other, except to the extent it may be otherwise stated above or to the extent that any such embodiments may be incompatible by virtue of their function or structure, as will be apparent to persons of ordinary skill in the art. Unless contrary to physical possibility, it is envisioned that (i) the methods/steps described herein may be performed in any sequence and/or in any combination, and (ii) the components of respective embodiments may be combined in any manner.

Processing of the various components of systems illustrated herein can be distributed across multiple machines, networks, and other computing resources. Two or more components of a system can be combined into fewer components. Various components of the illustrated systems can be implemented in one or more virtual machines or an isolated execution environment, rather than in dedicated computer hardware systems and/or computing devices. Likewise, data stores can represent physical and/or logical data storage, including, e.g., storage area networks or other distributed storage systems. Moreover, in some embodiments the connections between the components shown represent possible paths of data flow, rather than actual connections between hardware. While some examples of possible connections are shown, any of the subset of the components shown can communicate with any other subset of components in various implementations.

Examples have been described with reference to flow chart illustrations and/or block diagrams of methods, apparatus (systems), and computer program products. Each block of the flow chart illustrations and/or block diagrams, and combinations of blocks in the flow chart illustrations and/or block diagrams, may be implemented by computer program instructions. Such instructions may be provided to a processor of a computing device for execution thereby resulting in performance of the operations described in the flow chart by one or more components of the networked environments illustrated or described herein. These computer program instructions may also be stored in a non-transitory computer-readable memory that can direct a computer or other programmable data processing apparatus to operate in a particular manner, such that the instructions stored in the computer-readable memory produce an article of manufacture including instruction means which implement the acts specified in the flow chart and/or block diagram block or blocks. The computer program instructions may also be loaded to a computing device or other programmable data processing apparatus to cause operations to be performed on the computing device or other programmable apparatus to produce a computer implemented process such that the instructions which execute on the computing device or other programmable apparatus provide steps for implementing the acts specified in the flow chart and/or block diagram block or blocks.

In some embodiments, certain operations, acts, events, or functions of any of the algorithms described herein can be performed in a different sequence, can be added, merged, or left out altogether (e.g., not all are necessary for the practice of the algorithms). In certain embodiments, operations, acts, functions, or events can be performed concurrently, e.g., through multi-threaded processing, interrupt processing, or multiple processors or processor cores or on other parallel architectures, rather than sequentially.

What is claimed is:

1. A computerized method, comprising:
performing an automated scanning, based on a user profile, of one or more webpages for one or more candidate accounts forming a set of candidate accounts, wherein the user profile includes identifying data provided by a particular individual to whom the user profile corresponds, and wherein the candidate account includes information having a level of similarity to the user profile;
performing an automated analysis of each of the set of candidate accounts to determine a score indicative of a likelihood for each candidate account of the set of candidate accounts; and
generating a graphical user interface illustrating at least a subset of the set of candidate accounts, wherein the graphical user interface is configured to receive user feedback indicating that a first candidate account of the subset of the set of candidate accounts is to be deleted from storage.

2. The computerized method of claim 1, further comprising:
generating removal instructions based on the user feedback; and
automatically transmitting the removal instructions to a webpage to which the first candidate account corresponds or to an email of a business entity storing the first candidate account.

3. The computerized method of claim 2, wherein automatically transmitting the removal instructions to the webpage to which the first candidate account corresponds includes automatically populating fields within a form or web portal provided by the webpage.

4. The computerized method of claim 1, wherein the automated scanning is performed by one or more programming scripts configured, upon execution by one or more processors, to access the one or more webpages and attempt to access user accounts or user data stored or accessible by the one or more webpages based on a predetermined structure of the one or more webpages.

5. The computerized method of claim 1, wherein the automated analysis of each of the set of candidate accounts includes processing each of the set of candidate accounts and the user profile with a trained machine learning model to determine a similarity score for each of the set of candidate accounts relative to the user profile.

6. The computerized method of claim 5, further comprising performing a feature embedding process on each of the set of candidate accounts and the user profile, wherein resultant feature embeddings are provided to the trained machine learning model as input.

7. The computerized method of claim 1, wherein the automated analysis of each of the set of candidate accounts includes generating a feature embedding for each of the set of candidate accounts and the user profile and determining a similarity between (i) the feature embedding for each of the set of candidate accounts, and (ii) the feature embedding of the user profile.

8. A computing device, comprising:
a processor; and
a non-transitory computer-readable medium having stored thereon instructions that, when executed by the processor, cause the processor to perform operations including:
performing an automated scanning, based on a user profile, of one or more webpages for one or more candidate accounts forming a set of candidate accounts, wherein the user profile includes identifying data provided by a particular individual to whom the user profile corresponds, and wherein the candidate account includes information having a level of similarity to the user profile;
performing an automated analysis of each of the set of candidate accounts to determine a score indicative of a likelihood for each candidate account of the set of candidate accounts; and
generating a graphical user interface illustrating at least a subset of the set of candidate accounts, wherein the graphical user interface is configured to receive user feedback indicating that a first candidate account of the subset of the set of candidate accounts is to be deleted from storage.

9. The computing device of claim 8, wherein the operations further include:
generating removal instructions based on the user feedback; and
automatically transmitting the removal instructions to a webpage to which the first candidate account corresponds or to an email of a business entity storing the first candidate account.

10. The computing device of claim 9, wherein automatically transmitting the removal instructions to the webpage to which the first candidate account corresponds includes automatically populating fields within a form or web portal provided by the webpage.

11. The computing device of claim 8, wherein the automated scanning is performed by one or more programming scripts configured, upon execution by one or more processors, to access the one or more webpages and attempt to access user accounts or user data stored or accessible by the one or more webpages based on a predetermined structure of the one or more webpages.

12. The computing device of claim 8, wherein the automated analysis of each of the set of candidate accounts includes processing each of the set of candidate accounts and the user profile with a trained machine learning model to determine a similarity score for each of the set of candidate accounts relative to the user profile.

13. The computing device of claim 12, wherein the operations further include:
performing a feature embedding process on each of the set of candidate accounts and the user profile, wherein resultant feature embeddings are provided to the trained machine learning model as input.

14. The computing device of claim 8, the automated analysis of each of the set of candidate accounts includes generating a feature embedding for each of the set of candidate accounts and the user profile and determining a similarity between (i) the feature embedding for each of the set of candidate accounts, and (ii) the feature embedding of the user profile.

15. A non-transitory computer-readable medium having stored thereon instructions that, when executed by one or more processors, cause the one or more processor to perform operations including:
performing an automated scanning, based on a user profile, of one or more webpages for one or more candidate accounts forming a set of candidate accounts, wherein the user profile includes identifying data provided by a particular individual to whom the user profile corresponds, and wherein the candidate account includes information having a level of similarity to the user profile;
performing an automated analysis of each of the set of candidate accounts to determine a score indicative of a likelihood for each candidate account of the set of candidate accounts; and
generating a graphical user interface illustrating at least a subset of the set of candidate accounts, wherein the graphical user interface is configured to receive user feedback indicating that a first candidate account of the subset of the set of candidate accounts is to be deleted from storage.

16. The non-transitory computer-readable medium of claim 15, wherein the operations further include:
generating removal instructions based on the user feedback; and
automatically transmitting the removal instructions to a webpage to which the first candidate account corresponds or to an email of a business entity storing the first candidate account.

17. The non-transitory computer-readable medium of claim 16, wherein automatically transmitting the removal instructions to the webpage to which the first candidate account corresponds includes automatically populating fields within a form or web portal provided by the webpage.

18. The non-transitory computer-readable medium of claim 15, wherein the automated scanning is performed by one or more programming scripts configured, upon execution by one or more processors, to access the one or more webpages and attempt to access user accounts or user data stored or accessible by the one or more webpages based on a predetermined structure of the one or more webpages.

19. The non-transitory computer-readable medium of claim 15, wherein the automated analysis of each of the set of candidate accounts includes processing each of the set of candidate accounts and the user profile with a trained machine learning model to determine a similarity score for each of the set of candidate accounts relative to the user profile.

20. The non-transitory computer-readable medium of claim 19, wherein the operations further include: performing a feature embedding process on each of the set of candidate accounts and the user profile, wherein resultant feature embeddings are provided to the trained machine learning model as input.
